(19) United States
(12) Patent Application Publication
(10) Pub. No.: US 2002/0112231 A1
(43) Pub. Date: Aug. 15, 2002

(54) Software distribution at a multi-processor telecommunications platform

(76) Inventors: Arne Lundback, Skogas (SE); Roger Abrahamsson, Varmdo (SE); Jan Homle, Hagersten (SE)

Correspondence Address: NIXON & VANDERHYE P.C., 8th Floor, 1100 North Glebe Road, Arlington, VA, 22201-4714, US

(21) Appl. No.: 09/734,947

(22) Filed: Dec. 13, 2000

(51) Int. Cl. G06F 9/445

(52) U.S. Cl. 717/170; 717/173; 717/178; 707/203

(57) ABSTRACT

The distribution of load modules to processors of a telecommunication platform (20) vis facilitated by software allocation manage objects (SWA-MAOs). Each software allocation manage object associates a hardware location manage object (representing a hardware or equipment location within the platform or node) with a repertoire (R-MAO). The repertoire is a manage object which specifies one or more hardware entities, and for each specified hardware entity provides a list of one or more potentially downloadable load modules. When the presence of a new hardware entity is detected at a hardware location in the telecommunications node or platform, a node support function downloads an appropriate load module(s) to the new hardware entity, using the repertoire forming the software allocation manage object which affects the hardware location to determine which load module(s) are appropriate for the downloading.

This application is related to U.S. patent application Ser. No. 09/467,018 filed Dec. 20, 1999, entitled “Internet Protocol Handler for Telecommunications Platform With Processor Cluster”; as well as to the following simultaneously-filed U.S. patent applications: U.S. patent application Ser. No. ______, (attorney docket: 2380-182), entitled “Telecommunications Platform With Processor Cluster and Method of Operation Thereof”; U.S. patent application Ser. No. 09/467,018 filed Dec. 20, 1999, entitled “Internet Protocol Handler for Telecommunications Platform With Processor Cluster”; and U.S. patent application Ser. No. ______ (attorney docket: 2380-183), entitled “Replacing Software At A Telecommunications Platform”, all of which are incorporated herein by reference.

### BACKGROUND

1. Field of the Invention

The present invention pertains to multi-processor system, and particularly to the distribution of software to processors of the multi-processor system.

2. Related Art and Other Considerations

In a multi-processor system, there must be some mechanism for configuring how software should be distributed to the processors of the system. The most common approach is for a human operator simply to predict for which processor the software is best suited, and to assign straight away the software to the predicted processor. However, this rudimentary approach is problematic for complex systems. In making software assignments, the operator should be aware of the characteristics of the different processors of the system and the characteristics and behavior of the software.

In large systems, such as some telecommunications systems, such configuration activities are prone to be extremely complicated. For example, a multi-processor system can be situated at a node of a cellular telecommunications system, such as a base station or a radio network controller (RNC), also known as a base station controller (BSC). With respect to hardware, such nodes tend to have several subracks, with each subrack having numerous slots into which device boards or the like can be inserted. Each device board can be equipped with one or more loadable hardware entities into which devices such as processors may be inserted. Software must be distributed to each of the processors. Therefore, in view of the fact that there can be many subracks each with many slots, the complexity of software distribution to the numerous processors can be appreciated.

What is needed therefore, and an object of the present invention, is a user-friendly mechanism for facilitating software distribution in a multi-processor system.

### BRIEF SUMMARY OF THE INVENTION

The distribution of load modules to processors of a telecommunication platform is facilitated by software allocation manage objects. Each software allocation manage object associates a hardware location manage object (representing a hardware or equipment location within the platform or node) with a repertoire. The repertoire is a manage object that represents a function and groups a number (e.g., one or more) of load modules implementing that function for different hardware types. In other words, the repertoire contains information of what load modules shall be downloaded to a certain hardware type in order to active a certain function of the telecommunication platform.

Preferably the software allocation manage objects are created and operate in context of a multi-processor telecommunications node or platform having a main processor cluster (MPC). A management adaptation layer in a cluster support function distributed through the main processor cluster (MPC) hosts the software allocation manage objects.

In accordance with a software (load module) distribution operation of the invention, the cluster support function detects the presence of a new hardware entity installed in the telecommunications node or platform. The hardware entities which are mounted in the telecommunications node are preferably provided with certain product information which is pre-recorded in the hardware entity for the purpose of identifying the particular hardware entity. After the hardware entity is plugged into its hardware location and starts working, the cluster support function acquires the product identifying information of the newly installed or mounted hardware entity. Knowing the particular hardware location in which the hardware entity was plugged, the software distribution function can (by using a software allocation object that refers to that particular hardware location) track which repertoire the same software allocation object refers to. This repertoire specifies what load modules shall be loaded to the hardware entity plugged into that particular hardware location, depending on the type of hardware entity actually plugged in. When the hardware type for that location is determined (e.g., by configuration data) or physically inserted, the software distribution function is able to load the load module(s) as specified by the repertoire.

In addition to simple software allocation manage objects, there are three other distribution types of software allocation manage objects—multiple software allocation manage objects; redundant software allocation manage objects; and partitioning software allocation manage objects. In the multiple software allocation manage objects, the referenced repertoire is loaded to all hardware entities situated in plural non-overlapping referenced hardware locations. The redundant software allocation manage object is used for repertoires containing at least one load module geared to run as a redundant pair, and is used to control on which processor the load module will be started as active and on which processor it will be started as standby. The partitioning software allocation manage object is used to state that each referenced repertoire is used on a fraction of the referenced hardware locations.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a telecommunications platform having a main processor cluster according to an embodiment of the invention.

FIG. 2 is a schematic view of showing distribution of Cluster Support Function throughout the main processor cluster of FIG. 1.

FIG. 3 is a diagrammatic view of a load module.

FIG. 4 is a diagrammatic view illustrating programs created from the load module of FIG. 3.

FIG. 5 is a diagrammatic view illustrating a layered management structure for telecommunications platform of FIG. 1.

FIG. 6 is a diagrammatic view illustrating manage object interface between a management client computer and the telecommunications platform or node of FIG. 1.

FIG. 7 is a schematic view of an example telecommunications node from equipment perspective.

FIG. 8 is a diagrammatic view of a portion of an instantiation of the manage object model, particularly showing hardware location manage objects for the example telecommunications node of FIG. 7.

FIG. 9 is a diagrammatic view of a portion of a management adaptation layer of cluster support function, particularly showing (in addition to hardware location manage objects) various repertoire manage objects and load module manage objects and their corresponding load modules.

FIG. 10 is a diagrammatic view of a software allocation object creation screen presented during execution of management application software at a management client computer for creation of a software allocation manage object.

FIG. 11 is a flowchart showing basic actions performed in an example software (load module) distribution operation according to a mode of the invention.

FIG. 12A is a diagrammatic view depicting the appearance of software allocation object creation screen upon creating a first scenario example software allocation manage object.

FIG. 12B is a diagrammatic view illustrating performance of the software (load module) distribution operation for the first scenario example of FIG. 12A.

FIG. 13A is a diagrammatic view depicting the appearance of software allocation object creation screen upon creating a second scenario example software allocation manage object.

FIG. 13B is a diagrammatic view illustrating performance of the software (load module) distribution operation for the second scenario example of FIG. 13A.

FIG. 14A, FIG. 14B, FIG. 14C, and FIG. 14D are diagrammatic views respectively illustrating relations of a simple software allocation manage object; a multiple software allocation manage object; a redundant software allocation manage object; and a partitioning software allocation manage object.

FIG. 15 is a schematic view of one example embodiment of a ATM switch-based telecommunications platform which can be utilized with the present invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

In the prior art, many telecommunications platforms have a single powerful processor which serves as a central processing resource for the platform. The central processing resource provides an execution environment for application programs and performs supervisory or control functions for other constituent elements of the platform. For example, the central processing resource executes software which controls or manages software executed by local processors of the platform (e.g., board processors). The local processors can, for example, host software for local control of a dedicated hardware performing a certain task. The central processing resource is normally much more powerful than the local processing resources.

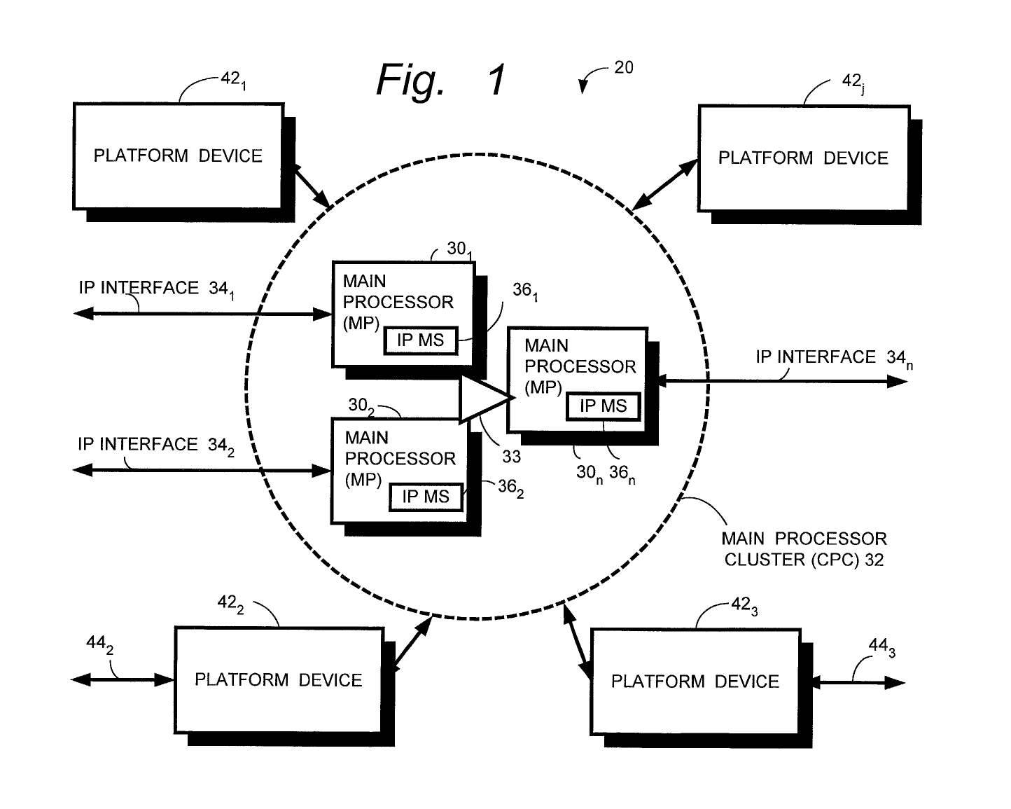

In contrast to a single main processor platform, FIG. 1 shows a generic multi-processor platform 20 of a telecommunications network, such as a cellular telecommunications network, for example, according to the present invention. The telecommunications platform 20 of the present invention has a central processing resource of the platform distributed to plural processors 30, each of which is referenced herein as a main processor or MP. Collectively the plural main processors 30 comprise a main processor cluster (MPC) 32. FIG. 1 shows the main processor cluster (MPC) 32 as comprising n number of main processors 30, e.g., main processors 30₁ through 30ₙ.

The main processors 30 comprising main processor cluster (MPC) 32 are connected by inter-processor communication links 33. The transport layer for communication between the main processors 30 is not critical to the invention. Furthermore, one or more of the main processors 30 can have an internet protocol (IP) interface 34 for connecting to data packet networks.

FIG. 1 shows j number of platform devices 42 included in telecommunications platform 20. The platform devices 42₁-42_{J} can, and typically do, have other processors mounted thereon. In some embodiments, the platform devices 42₁-42_{J} are device boards. Although not shown as such in FIG. 1, some of these device boards have a board processor (BP) mounted thereon for controlling the functions of the device board, as well as special processors (SPs) which perform dedicated tasks germane to the telecommunications functions of the platform.

Although not specifically illustrated as such, there are communication channels from all platform devices 42 to all main processors 30 over an intra-platform communications system. Examples of intra-platform communications system include a switch, a common bus, and can be packet oriented or circuit switched. In addition, there are communication channels (over inter-processor communication links 33) between all main processors 30 in the main processor cluster (MPC) 32.

Some of the platform devices 42 have connections leading externally from telecommunications platform 20, e.g., connect to other platforms or other network elements of the telecommunications system. For example, platform device 422 and platform device 423 are shown as being connected to inter-platform links 442 and 443, respectively. The inter-platform links 442 and 443 can be bidirectional links carrying telecommunications traffic into and away from telecommunications platform 20. The traffic carried on inter-platform links 442 and 443 can also be internet protocol (IP) traffic which is involved in or utilized by an IP software application(s) executing in management service (IP MS) section 36 of one or more main processors 30.

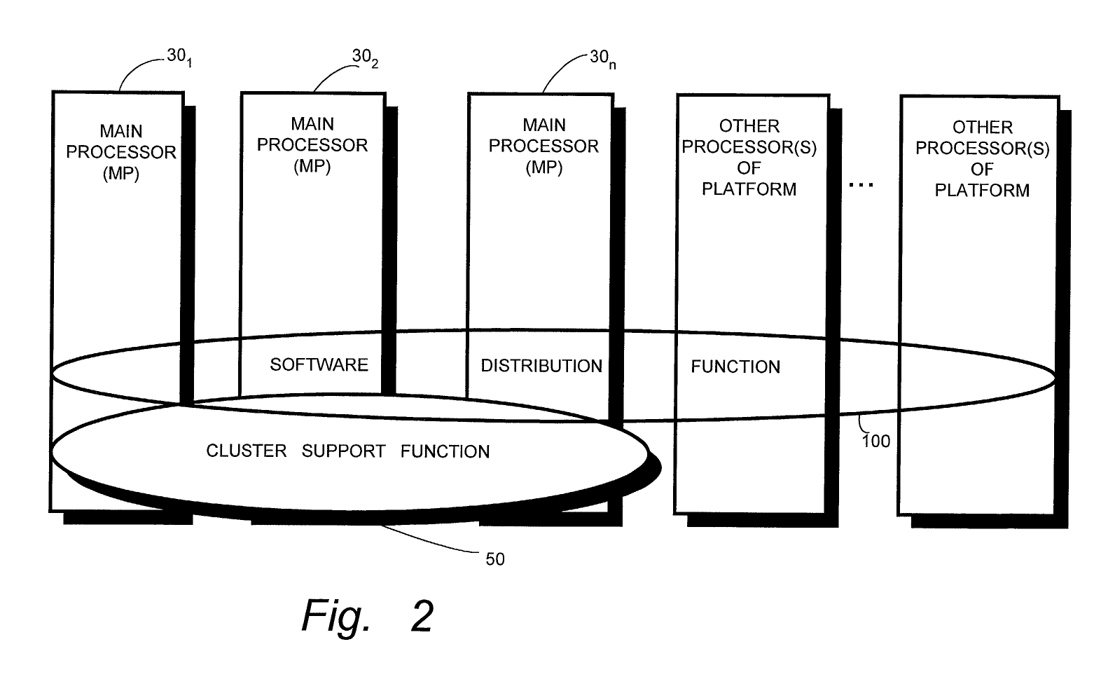

As shown in FIG. 2 and hereinafter described, main processor cluster (MPC) 32 has cluster support function 50 which is distributed over the main processors 30 belonging to main processor cluster (MPC) 32. The cluster support function 50 enables a software designer to implement application software that is robust against hardware faults in the main processors 30 and against faults attributable to software executing on main processors 30. Moreover, cluster support function 50 facilitates upgrading of application software during run time with little disturbance, as well as changing processing capacity during run time by adding or removing main processors 30 of main processor cluster (MPC) 32.

The main processors 30 of main processor cluster (MPC) 32 execute various programs that result from the loading of respective load modules. A load module is generated by a compiler or similar tool, and contains binary code generated from one or more source code files. Those source code file(s) contain one or more process definitions. The process definitions contain the sequence of source code instructions that are executed in one context as one process thread. The load module is output from the load module generating tool (e.g., compiler) as a file, and the software of the load module is presented to the system as a file. A load module includes certain “meta-data” which is used, e.g., to facilitate downloading of the load module. Examples of such meta-data include the following: target processor type; start phase; whether the load module is involved in redundancy or not. The meta-data is set at load module creation time and is stored at the node in a way so it will be connected to the load module to which it belongs. Preferably the meta-data is stored as a header in the beginning of a file with the load module itself.

FIG. 3 shows a load module as a software object which wraps together a group of related potentially executable processes. In particular, FIG. 3 shows an example load module (LM) 60 comprising process definitions 62₁-62_{w}, with process definition 62₁ being the root process definition of the load module (LM) 60. The load module is created when the related process definitions are compiled and linked together.

A program is a running instance of a load module. That is, when a program is created when a load module is loaded into a processor. Thus, a program exists only in run time memory (RAM) of a processor and is created as a consequence of the loading of the corresponding load module. A program can be considered to contain one or more processes (corresponding to the process definitions of the load module whose loading created the program), and is represented in the operating system as a group of process blocks that contain, among other things, a program counter, a stack area, and information regarding running, suspension, and waiting states. The execution of a program can be aborted or suspended by the operating system, and then execution resumed subsequently.

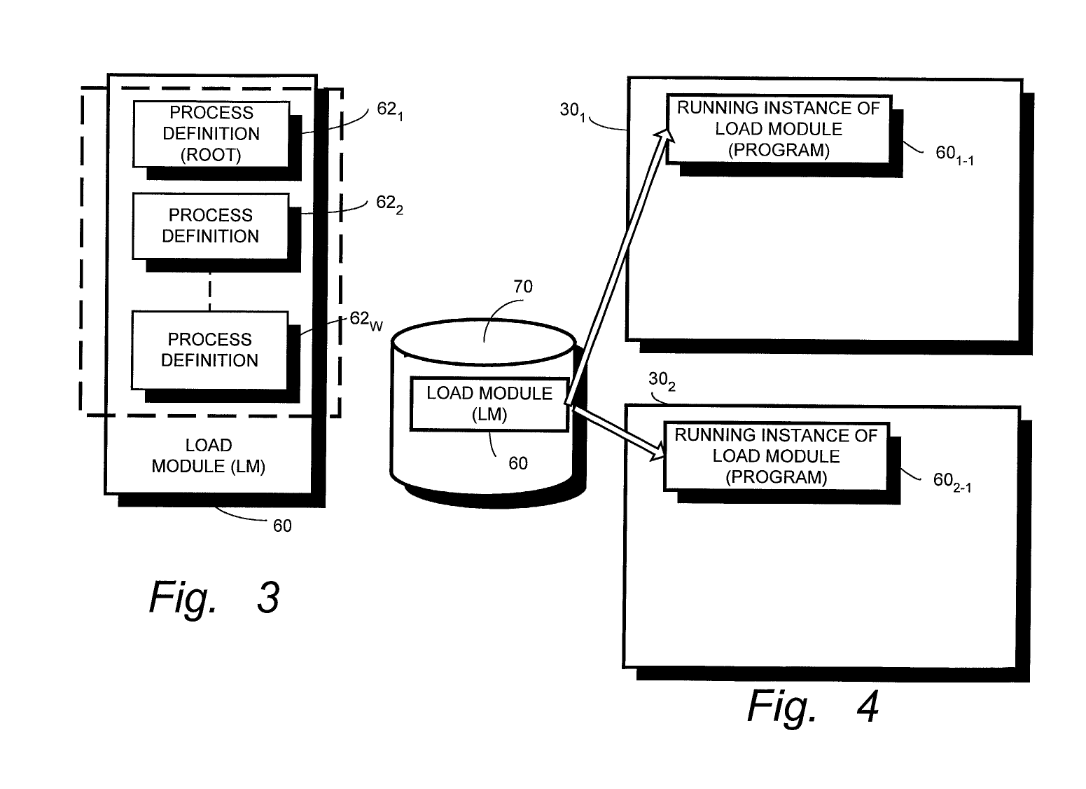

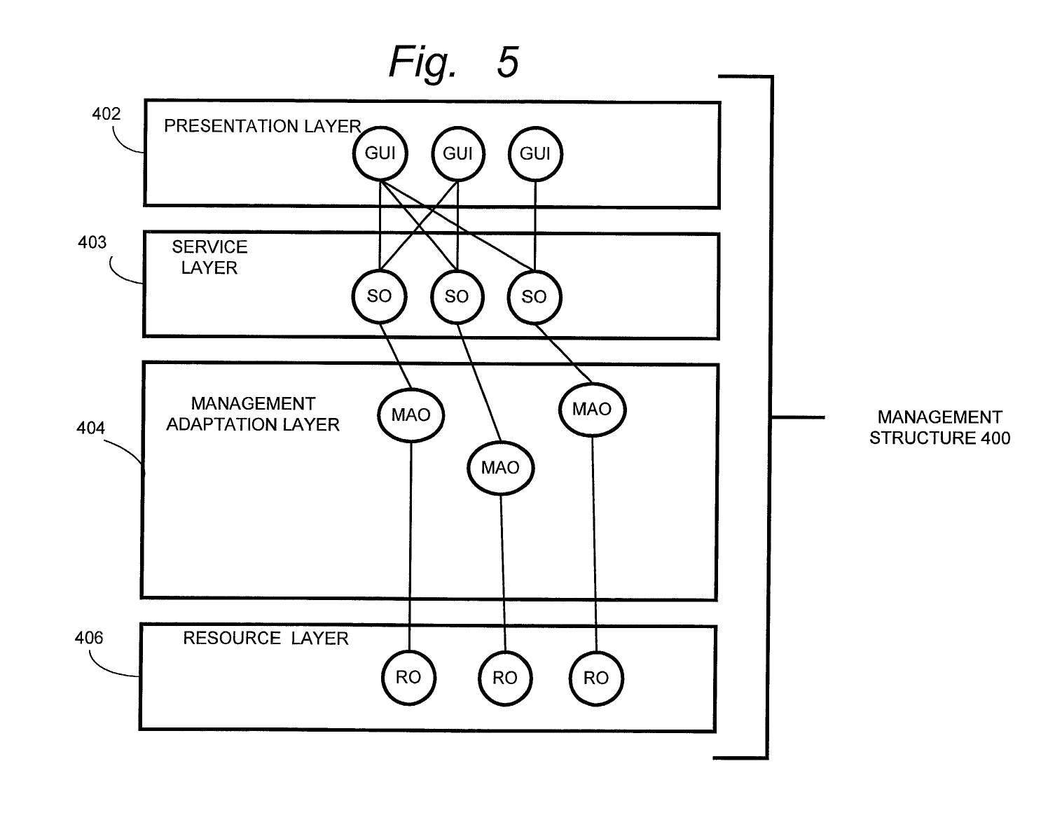

FIG. 4 shows load module 60 as stored in a persistent memory such as a data base 70. In addition, FIG. 4 shows that that load module 60 has been loaded onto processor 30₁, resulting in creation of a running instance of load module 60, i.e., program 60₁₋₁. Similarly, load module 60 has been loaded onto processor 302, resulting in creation of a running instance of load module 60, i.e., program 60₂₋₁. In this embodiment, each load module is loaded once to a processor, and each processor is typically loaded with several different load modules.

It is the control (e.g., by an operator) of the distribution of load modules to which this invention primarily pertains. In connection with this distribution of load modules, the telecommunications platform 20 has a software distribution function 100. As explained hereinafter, operation of the software distribution function 100 involves software management activities which affects processors within the main processor cluster (MPC) 32, as well as processors on device boards that are not part of the cluster that also have software configured in accordance with the present invention.

The software distribution function 100 can be viewed as having a management structure 400 such as that shown in FIG. 5. The management structure comprises: presentation layer 402; service layer 403; management adaptation layer 404; and resource layer 406. Presentation layer 402 has graphical user interfaces (GUIs). The service layer has service objects SO which provide the operator with different management services, e.g., a configuration service, an alarm service, an inventory service, a log service, etc.. A graphical user interface (GUI) connectes to one or several service objects SO. The management adaptation layer 404 has manage adaptation objects (MAOs). Each service object SO connects to one, to several, or to all manage adaptation objects (MAOs). Resource layer has resource objects (ROs). A resource object (RO) represents the real resource shown to the operator through a manage object (MO). Resource objects (ROs) can be, e.g., for hardware or software, example resource objects (ROs) being a processor on a device board, a load module (LM), connections, physical ports, etc. Each manage adaptation object (MAO) connects to one or several resource objects (ROs).

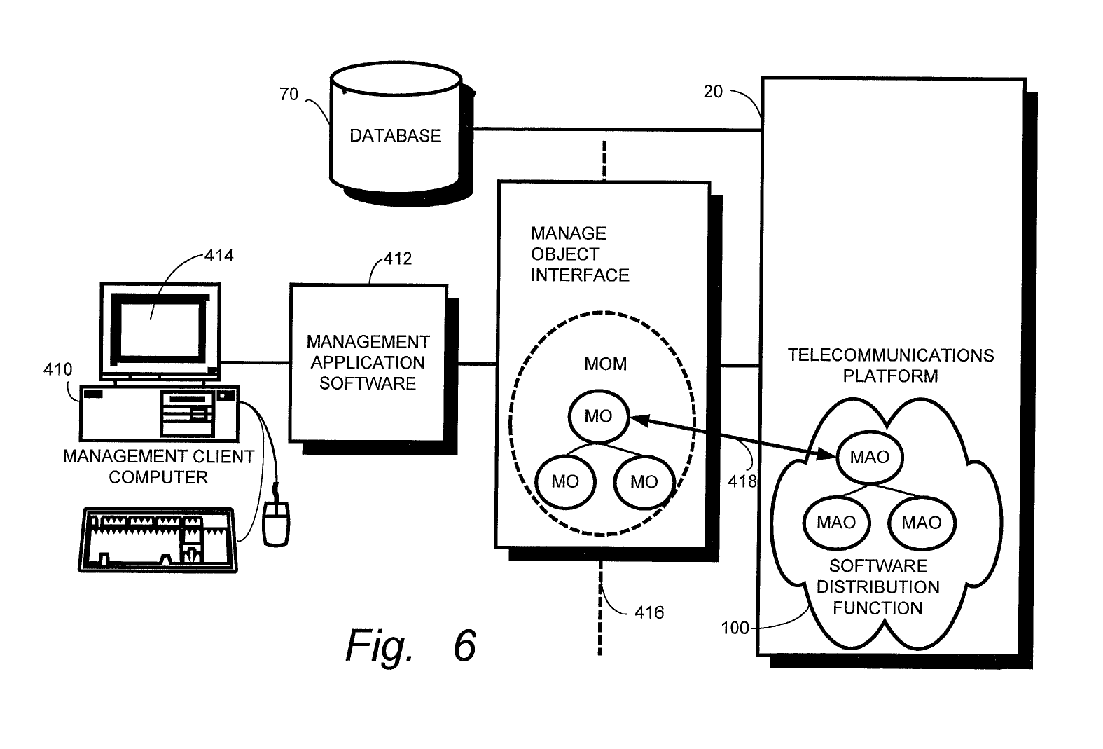

FIG. 6 shows a management client computer 410 employed to manage telecommunications platform or node 20. The management client computer 410 executes management application software 412, and has a display device 414. FIG. 6 illustrates that telecommunications platform 20 has a database memory 70. The database memory 70, although illustrated as a peripheral memory in FIG. 6, can take various forms, such as (for example) a hard disk or semiconductor board (e.g., RAM) memory.

FIG. 6 also shows an abstract manage object interface 416 between management client computer 410 (with its management application software 412) and telecommunications node 20. The manage object interface 416 has a number of manage objects (MOs) which collectively form a manage object model (MOM). The manage objects (MOs) comprise an object tree. As indicated by the doubleheaded arrow 418, the manage objects (MOs) have corresponding manage adaptation objects (MAOs) in management adaptation layer 404. There is a 1:1 correspondence between a MO and a MAO.

As used herein, the term “manage object” can refer collectively to both a manage object (MO) in manage object interface 416 and its corresponding manage adaptation object (MAO) in manage adaptation layer 404 (see FIG. 5). As described herein, there are various types of manage objects, including manage objects for load modules (LM-MAO); hardware type or hardware product manage objects (HT-MAO); resource or hardware location manage objects (HL-MAO); repertoire manage objects (R-MAO); and software allocation (SWA) manage objects (SWA-MAO).

For each manage object (MO), four methods or operations are provided. A method is a way in which an operator can manipulate the manage object, e.g., for managing the system. The four methods are: create; delete; set; and get. The create method is used by an operator to create a manage object, e.g., a software allocation object. The delete method is used by the operator to delete a manage object (MO). The set and get methods are used to read or write attributes of a manage object, e.g., to determine to which slots a software allocation object refers (relations are implemented as attributes).

The present invention facilitates the distribution of load modules to processors of a telecommunication platform by permitting an operator to create software allocation manage objects. Each software allocation manage object associates a hardware location manage object (representing a hardware or equipment location within the platform or node) with a repertoire. The repertoire is a manage object which specifies one or more hardware entities, and for each specified hardware entity provides a list of one or more potentially downloadable load modules.

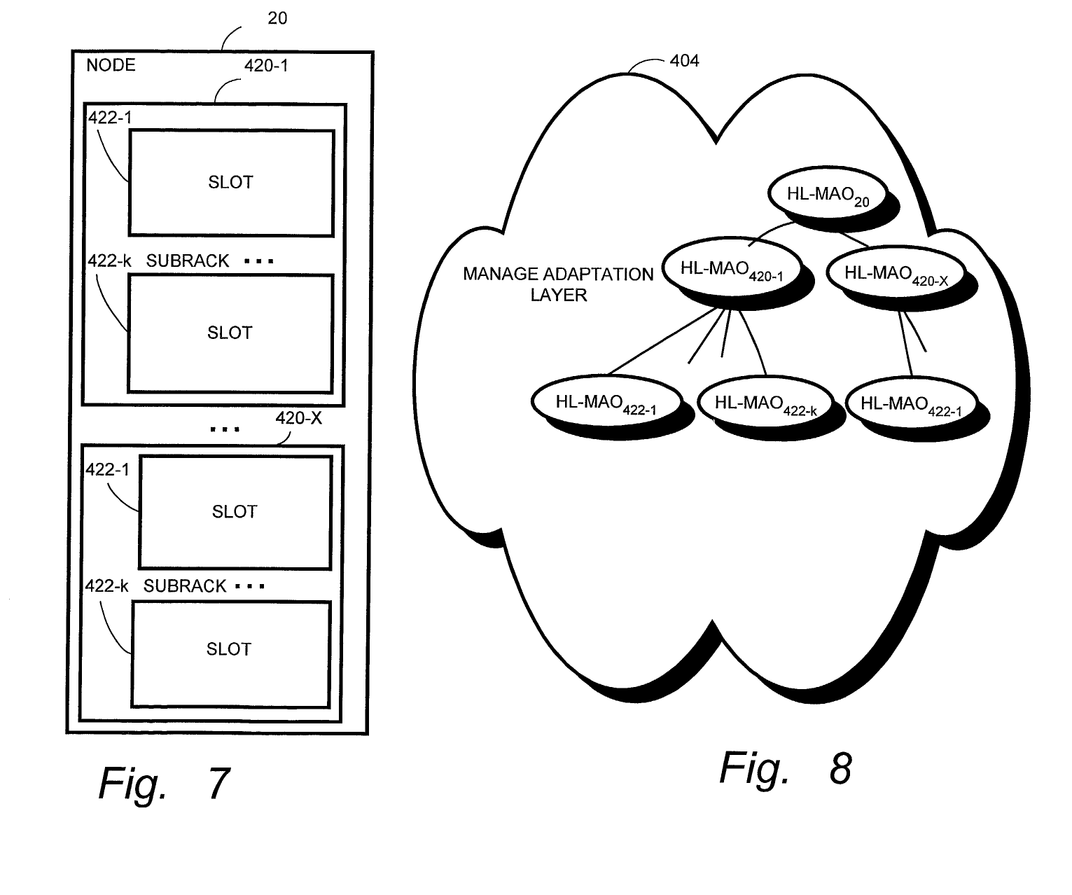

The concept of hardware location is understood in conjunction, e.g., with FIG. 7, which illustrates an example telecommunications node. As seen in FIG. 7, from an equipment or hardware perspective the platform or node 20 comprises a network element (the node itself) having plural subracks 420-1 to 420-X. Each subrack has plural slots 422-1 to 422-k, with each slot 422 possibly being equipped with a circuit board, the circuit board in turn having one or several loadable units. In other words, a node 20 can have plural subracks (e.g., a main subrack and extension subracks). A subrack 420 has an unillustrated backplane, which has various slots 422. Each of the slots 422 of the backplane can receive a circuit board (e.g., device board) or circuit card. Examples of such circuit boards include switch plane (switch core) board (SCB); a switch extension board (SXB); a main processor board (MPB); a special purpose processor board (SPB); and an exchange terminal (ET).

Thus, from FIG. 7 it can be surmised that there are plural (e.g., three) levels of hardware location entities—the node or element level, the subrack level, and the slot (board) level. In accordance with this hierarchical arrangement of hardware location entities, the telecommunications node 20 has a corresponding hierarchy of hardware locations—(1) node location; (2) subrack location; (3) slot (board) location. Moreover, in accordance with the present invention, as shown in FIG. 8, each hardware location of telecommunications node 20 has a corresponding hardware location manage object (HL-MAO) in manage adaptation layer 404. For example, subrack 420-1 has a corresponding hardware location manage object HL-MAO₄₂₀₋₁; slot 422-1 in subrack 420-1 has a corresponding hardware location manage object HL-MAO₄₂₂₋₁; and so forth. Not all hardware location manage objects are shown in FIG. 8, it being understood by branched descending lines from FIG. 8 that plural manage objects emanate at various lower levels of the hierarchial tree.

As mentioned above, the repertoire of the present invention is a manage object which defines a software implemented function as one or several load modules. Each repertoire specifies one or more hardware type entities, and for each specified hardware type entity provides a list of one or more load modules which are potentially downloadable to the hardware type entity. Each repertoire can be viewed as a table with columns, including a first column which lists the particular hardware type entities to which the repertoire pertains, and a second column listing the potentially downloadable load modules for each such entity.

For example, Table 1 shows a first example repertoire manage object (R-MAO₁) having the repertoire identity “MP Basic”. The repertoire represents a functionality which can be executed on the telecommunications platform 20. The two hardware type entities with which the repertoire MP Basic is usable are two main processor boards: (1) ROF 12345/6 Rev. R1; and (2) ROF 12345/6 Rev. R2. For processor board ROF 12345/6 Rev. R1 the functionality of the repertoire MP Basic can be obtained by downloading of two load modules to that board: (1) CXC333/1 Rev. A; and (2) CXC444 Rev. C. For processor board ROF 12345/6 Rev. R2 the functionality of the repertoire MP Basic can be obtained by downloading of two load modules to that board: (1) CXC333/2 Rev. A; and (2) CXC444 Rev. C. Thus, the repertoire MP Basic applies only to the lowest level of hardware type entities, i.e., a board into which a processor can be mounted.

TABLE 1
Repertoire Identity: MP Basic

| Hardware Type Entity | Load Modules |
|---|---|
| ROF 12345/6 Rev. R1 | CXC333/1 Rev. A |
| | CXC444 Rev. C |
| ROF 12345/6 Rev. R2 | CXC333/2 Rev. A |
| | CXC444 Rev. C |

Table 2 shows a second example repertoire manage object (R-MAO₂) having the repertoire identity “ET155”. Whereas the repertoire MP Basic of Table 1 concerned a single target hardware location entity, the repertoire ET155 involves plural targets. In this regard, the repertoire ET155 can be used to distribute both main processor load modules for main processor and board processor load modules for exchange terminals (ET device boards). Since main processors and ET device board are typically mounted in different hardware (HW) locations (slots), the repertoire ET155 is suitable to apply at a level higher than the slot level, e.g., the subrack level. The repertoire ET155 is usable for the following processor boards: (1) ROF 12345/6 Rev. R1; (2) ROF 12345/6 Rev. R2; and (3) ROF 9991 Rev. R1; and (4) ROF 9991 Rev. R2. For processor board ROF 12345/6 Rev. R1 the functionality of the repertoire ET155 can be obtained by downloading of load module CXC454 Rev. A. Also for processor board ROF 12345/6 Rev. R2 the functionality of the repertoire ET155 can be obtained by downloading of load module CXC454 Rev. A. For processor board ROF 99991 Rev. R1 the repertoire ET155 can facilitate downloading of two load modules: (1) CXC565/1 Rev. A; and (2) CXC878 Rev. C. For processor board ROF 99991 Rev. R2 the the functionality of repertoire ET155 can be obtained by downloading of two load modules: (1) CXC565/1 Rev. A; and (2) CXC878 Rev. D.

TABLE 2
Repertoire Identity: ET155

| Hardware Entity | Load Module(s) |
|---|---|
| ROF 12345/6 Rev. R1 | CXC454 Rev. A |
| ROF 12345/6 Rev. R2 | CXC454 Rev. A |
| ROF 9991 Rev. R1 | CXC565/1 Rev. A |
| | CXC878 Rev. C |
| ROF 9991 Rev. R2 | CXC565/1 Rev. A |
| | CXC878 Rev. D |

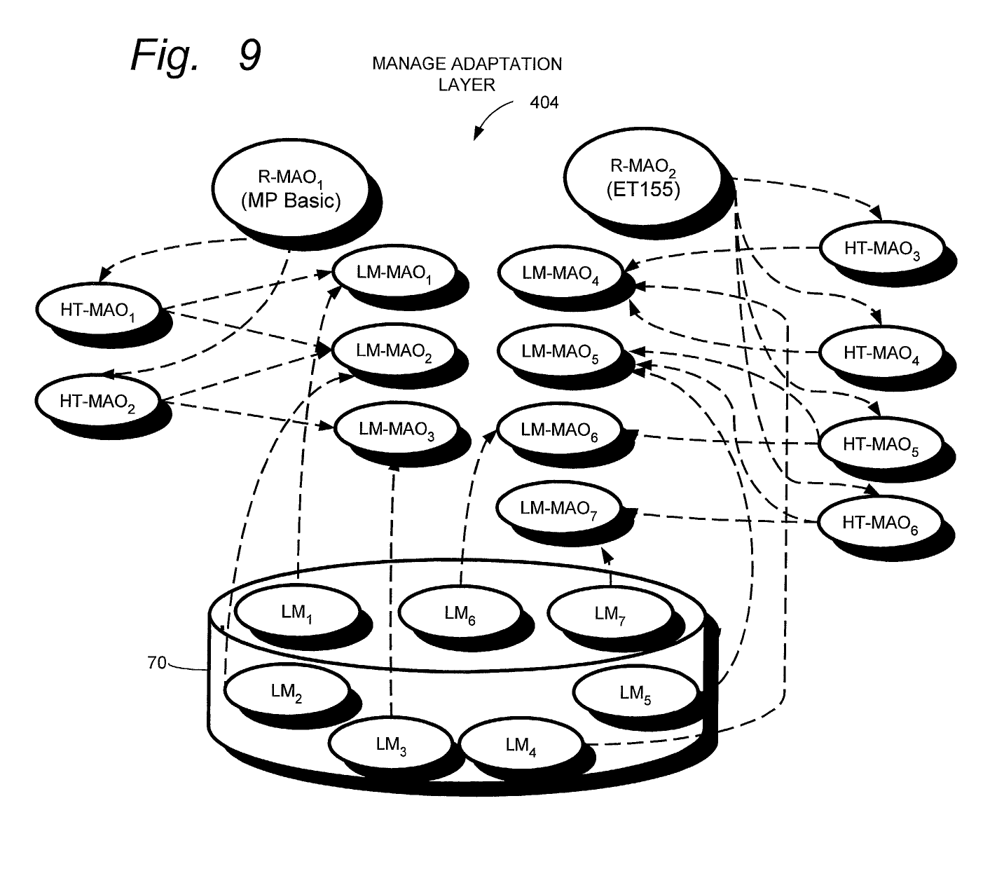

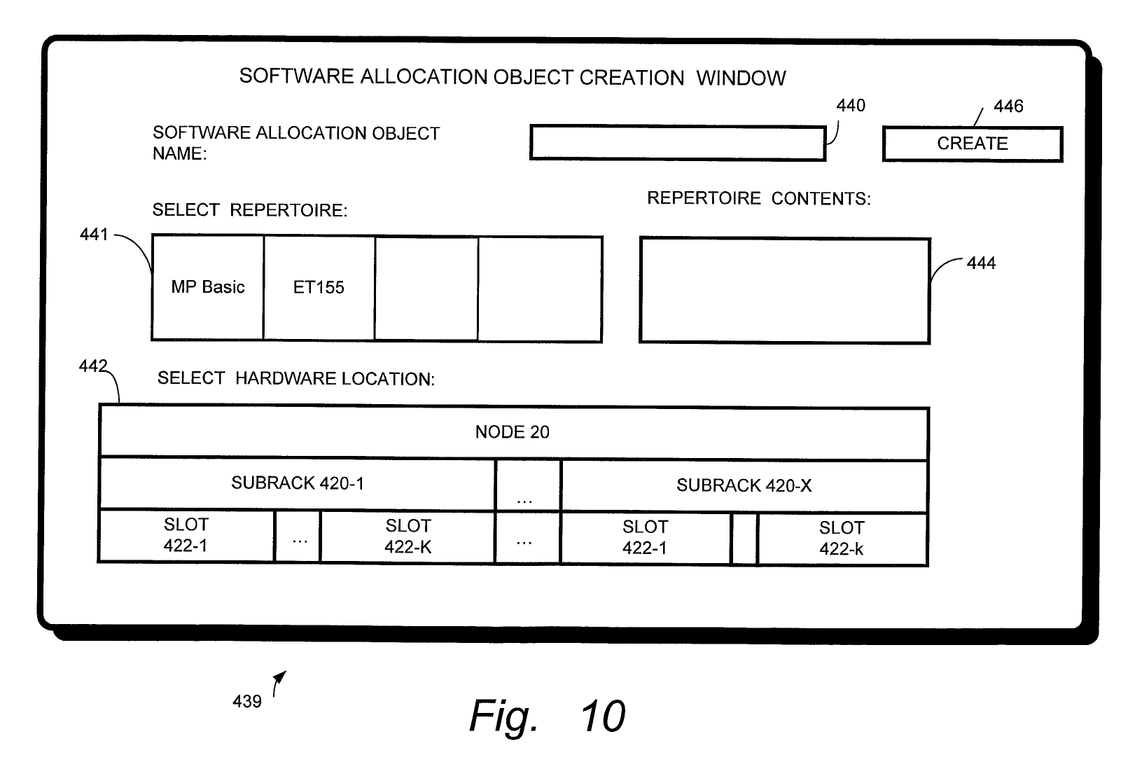

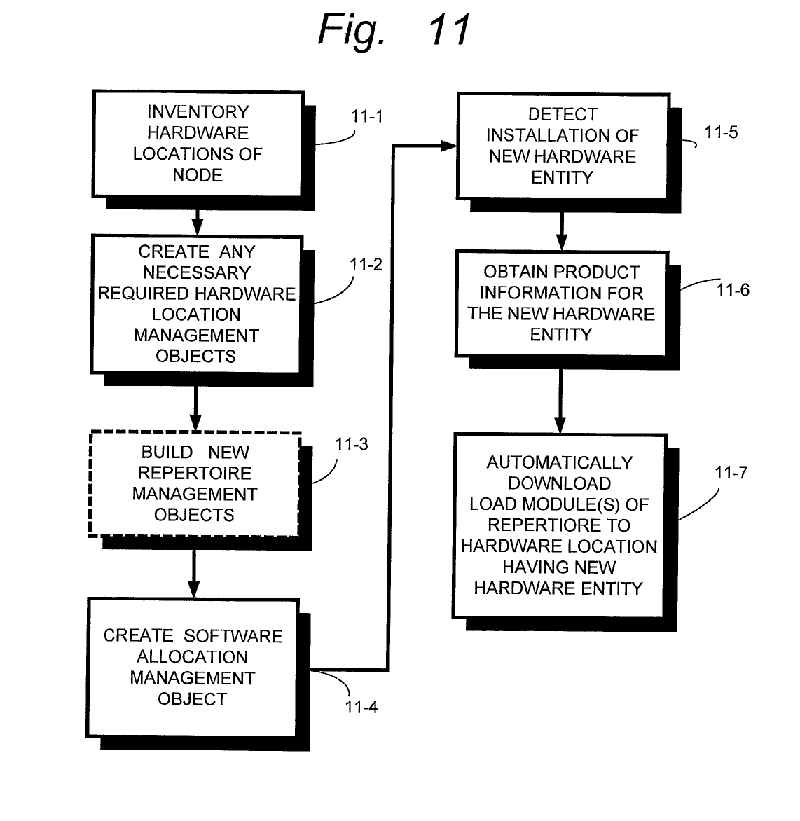

Since a repertoire is actually a repertoire manage object, manage adaptation layer 404 has a repertoire manage object (R-MAO) for each of the repertoires. In this regard, FIG. 9 shows manage adaptation layer 404 portion of software distribution function 100 as including manage object R-MAO₁ for the repertoire identity “MP Basic” and manage object R-MAO₂ for the repertoire identity “ET155”. Moreover, the load modules included in a repertoire such as repertoire MP Basic and repertoire ET155 are actually references to manage objects representing installed load modules. In other words, each installed load module (such as load module (LM) 60 in FIG. 4) has a corresponding manage adaptation object (MAO) in manage adaptation layer 404. For this reason, for the example scenario of Table 1 and Table 2 described above, FIG. 9 shows the following load module manage objects: LM-MAO₁ (for CXC333/1 Rev. A); LM-MAO₂ (for CXC444 Rev. C); LM-MAO₃ (for CXC333/2 Rev. A); LM-MAO₄ (for CXC454 Rev. A); LM-MAO₅ (for CXC565/1 Rev. A); LM-MAO₆ (for CXC878 Rev. C); and LM-MAO₇ (for CXC878 Rev. D). Each of these load module manage objects LM-MAO₁ through LM-MAO₇ is shown in FIG. 9 as having correspondence to a respective one of the installed load modules LM₁ through LM₇ in data base 70 of telecommunications platform 20 (see also FIG. 6).

FIG. 9 also shows that each repertoire manage object (R-MAO) references one ore more hardware type manage objects (HT-MAO). In the example described above, manage object R-MAO₁ for the repertoire identity “MP Basic” references hardware type manage object (HT-MAO₁) and hardware type manage object (HT-MAO₂). From Table 1 above, it will be understood that hardware type manage object (HT-MAO₁) refers (e.g., corresponds) to the hardware entity ROF 12345/6 Rev. R1, while hardware type manage object (HT-MAO₂) refers to the hardware entity ROF 12345/6 Rev. R2. Similarly, referring again to the above example, manage object R-MAO₂ for the repertoire identity “ET155” references hardware type manage objects HT-MAO₃ through hardware type manage object HT-MAO₆. From Table 2 above, it will be understood that hardware type manage objects HT-MAO₃, HT-MAO₄, HT-MAO₅, and HT-MAO₆, refers (e.g., corresponds) to the following respective hardware entities: ROF 12345/6 Rev. R1; ROF 12345/6 Rev. R2; ROF 9991 Rev. R1; and ROF 9991 Rev.

As further illustrated in FIG. 9, each hardware type manage object (HT-MAO) in turn refers to one or more load module manage objects (LM-MAO). The particular load module manage objects to which the hardware type manage objects of FIG. 9 refer are stated in Table 1 and Table 2.

FIG. 11 shows basic events or actions involved in an example software (load module) distribution operation according to an embodiment of the invention. Action 11-1 shows software distribution function 100 conducting an inventory of the hardware locations of telecommunications node 20, and in particular detecting the subracks and slots of the node. For each detected hardware location, software distribution function 100 ensures that there is a hardware location manage object (HL-MAO) in manage adaptation layer 404. If any hardware location manage objects (HL-MAO) are needed, they are created as action 11-2.

As action 11-3 of the software (load module) distribution operation, the operator has an opportunity to build any new repertoire manage objects which might be desired. Since software distribution function 100 has certain default repertoire manage objects, the creation or declaring of further repertoire manage objects is optional. For this reason, optional action 11-3 is shown in broken lines in FIG. 11.

In action 11-4 the operator creates a software allocation manage object. A software allocation object (SWA-MAO) is created as a result of operator action at management client computer 410.

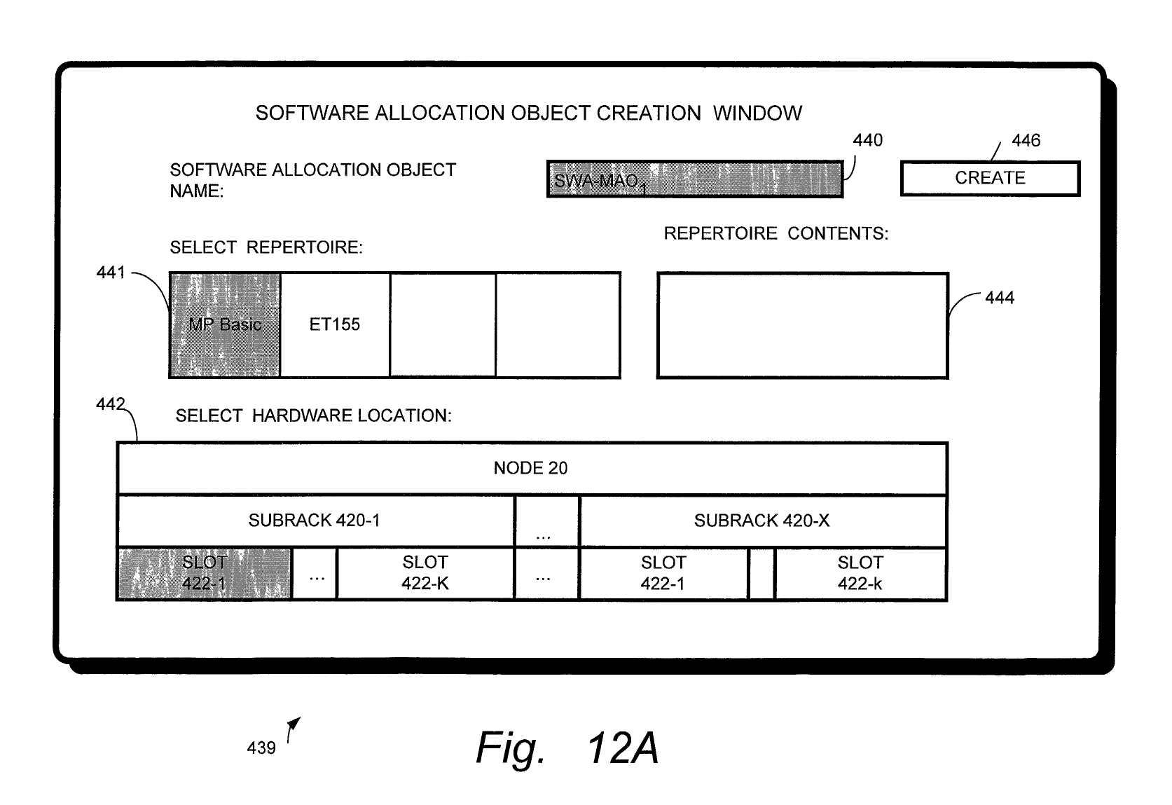

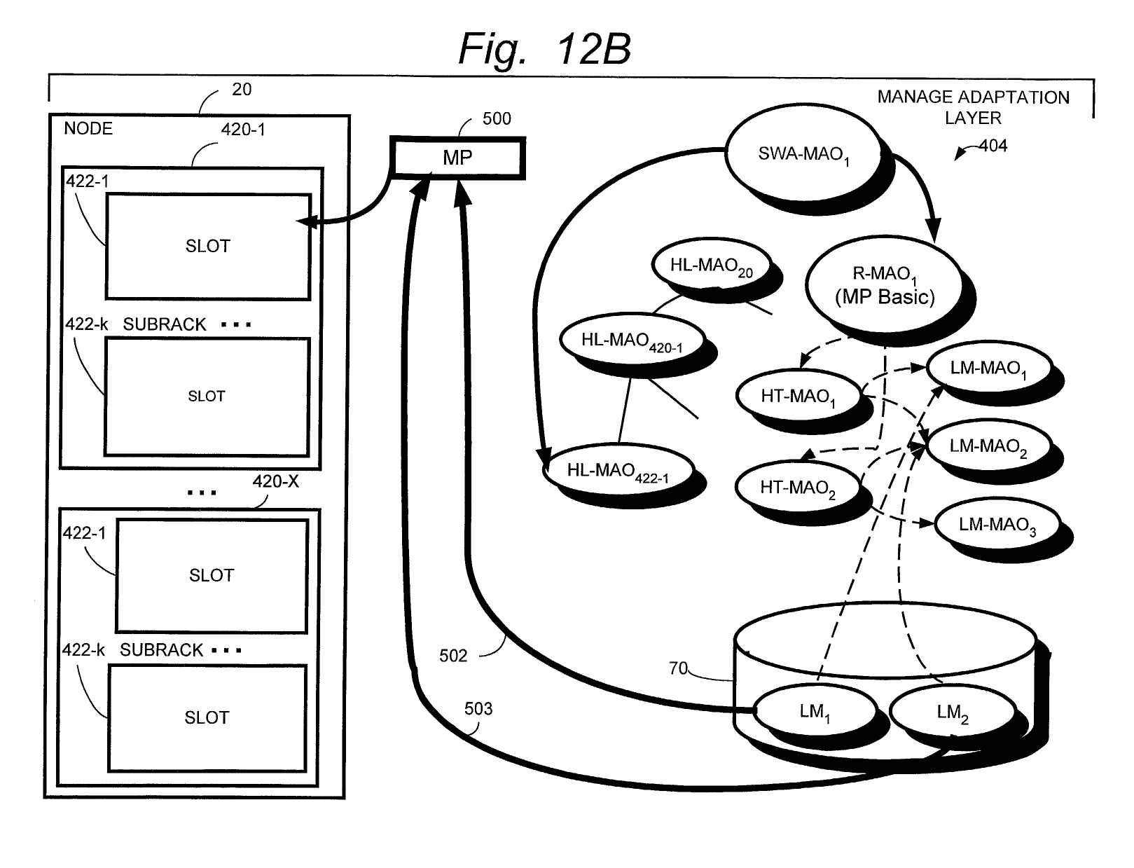

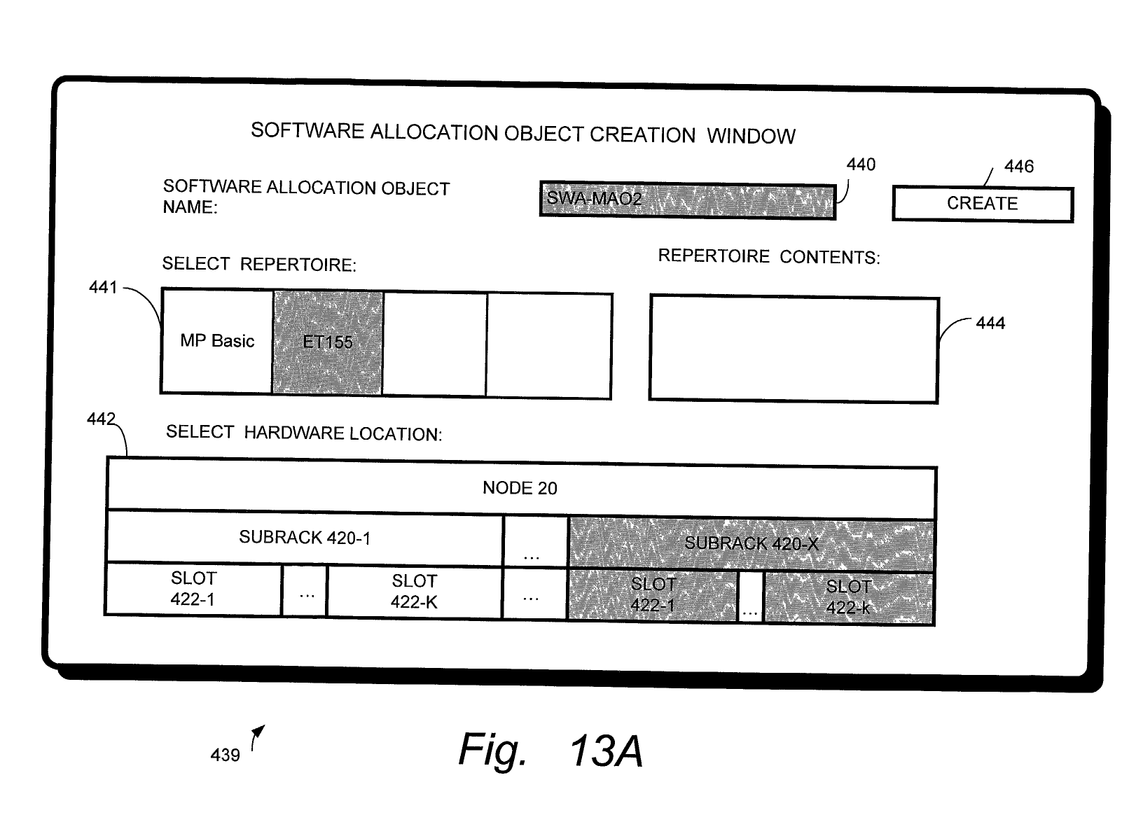

One non-limiting example way of creating a software allocation management object is now briefly described with reference to FIG. 10 and FIG. 12A-FIG. 12B. In this example, the management application software 412 executed by management client computer 410 provides a series of interactive menus which enables the operator to obtain a software allocation object creation screen or window 439 on display device 414 such as that shown in FIG. 10. The software allocation object creation screen 439 of FIG. 10 provides a dialog box 440 for a user/operator to enter a name or identification of the software allocation manage object which is about to be created. In addition, the user is provided with two lists from which to make selections for creation of the software allocation manage object. The first list 441 is a list of repertoires which can be selected. For the illustrated example involving Table 1 and Table 2, the list comprises the following repertoires: MP Basic and ET155. The second list 442 is a list of hardware locations which can be selected in connection with creation of the software allocation manage object. The second list 442 includes the following entries: telecommunications node 20; subracks 420-1 to 420-X; and slots 422-1 to 422-k for each subrack. In addition to first list 441 and second list 442, the software allocation object creation screen 439 optionally displays on screen insert 444 a display of the contents of a selected repertoire. A “create” button 446 is also provided on software allocation object creation screen 439.

FIG. 12A depicts the appearance of software allocation object creation screen 439 for a first example scenario of software distribution involving creation of a software allocation manage object SWA-MAO₁. The name or identifier for the created software allocation manage object (i.e., SWA-MAO₁) is shown in FIG. 12A as being entered in dialog box 440. For software allocation manage object SWA-MAO₁, the user has selected the repertoire MP Basic, as indicated by the shaded box for repertoire MP Basic in first list 441. In addition, the user has indicated that the repertoire MP Basic is to be used for downloading load modules to slot 422-1 of subrack 420-1. Upon clicking on the “create” button 446 of software allocation object creation screen 439, the software allocation manage object SWA-MAO₁ is created. Creation of the software allocation manage object SWA-MAO₁ essentially maps the repertoire MP Basic to slot 422-1 of subrack 420-1.

Creation of the software allocation manage object SWA-MAO₁ for the first example scenario of software distribution is illustrated in the management adaptation layer 404 of software distribution function 100 as depicted in FIG. 12B. The software allocation manage object SWA-MAO₁ has a relation to a repertoire manage object R-MAO₁ (for repertoire MP Basic) and a hardware location, particularly a hardware location manage object for slot 422-1 of subrack 420-1 (HL-MAO₄₂₂₋₁ under HL-MAO₄₂₀₋₁). It will be appreciated that, for simplicity, only portions of management adaptation layer 404 are illustrated in FIG. 12B (e.g., that only relevant portions pertaining to manage objects for repertoire MP Basic and subrack 420₁ are shown).

Returning to the software distribution operation of FIG. 11, after the creation of the software allocation manage object at action 11-4, the software distribution function 100 detects as action 11-5 the presence of a new hardware entity installed in telecommunications node 20. For sake of the first example scenario, assume that a main processor board 500 is mounted into slot 422-1 of subrack 420-1, as illustrated in FIG. 12B. Thus, with respect to the example scenario of FIG. 12A and FIG. 12B, as action 11-5, software distribution function 100 detects that main processor board (MP) 500 is mounted in slot 422-1 of subrack 420-1.

The hardware entities which are mounted in telecommunications node 20 are, in accordance with the present invention, preferably provided with certain product information which is pre-recorded in the hardware entity for the purpose of identifying the particular hardware entity. For example, the product information can be recorded in a memory of the hardware entity. A circuit board, for example, may have a flash memory ROM or the like in which the product identifying information is permanently recorded. Thus, as action 11-6 of the software (load module) distribution operation, and after the hardware entity is plugged into its hardware location and starts working, the software distribution function 100 acquires the product identifying information of the newly installed or mounted hardware entity.

Suppose, in connection with the example scenario of FIG. 12A and FIG. 12B, that the main processor board (MP) 500 mounted in slot 422-1 of subrack 420-1 is detected (at action 11-6) to be the hardware type entity having the product identifier ROF 12345/6 Rev. R1. As such, in accordance with the repertoire manage object MP Basic (R-MAO₁) associated with the affected hardware location (i.e., slot 422-1 of subrack 420-1), there are two load modules which are to be downloaded to the newly mounted hardware type entity (i.e., main processor board (MP) 500), e.g., load module CX333/1 Rev. A and load module CXC444 Rev. C.

Thus, a software allocation manage object was created at action 11-4. The software allocation manage object associated the hardware location with a repertoire manage object. In view of the creation of this software allocation manage object, as action 11-7 the software distribution function 100 automatically downloads load module(s) to the hardware location which was detected as having a new hardware entity. In particular, FIG. 12B depicts by arrows 502 and 503, respectively, the downloading of a copy of the installed version of the load modules of the repertoire, i.e., both load module CX333/1 Rev. A and CXC444 Rev. C. The downloading of the copies of the load module CX333/1 Rev. A [having load module LM₁ and load module manage object LM-MAO₁] and CXC444 Rev. C [having load module LM₂ and load module manage object LM-MAO₂] creates corresponding programs in the manner of FIG. 4 as previously discussed.

In the described example, the downloaded the copies of the load module are obtained from data base 70. However, the storage locations of the load modules are not critical to the invention, and can therefore be other locations such as a file on a hard drive of the node or the telecommunications platform 20. In any case, the allocation manage object load module contains information specifying where the software distribution function 100 is to fetch the load module(s) when downloading.

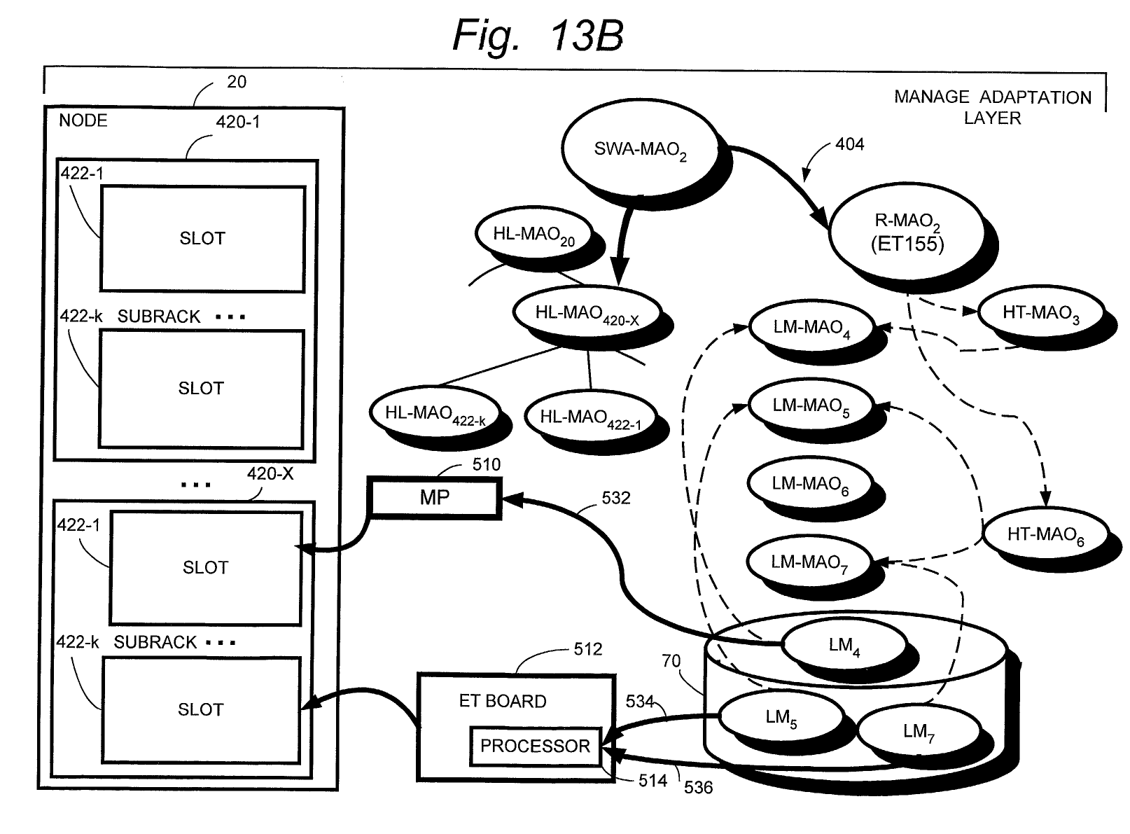

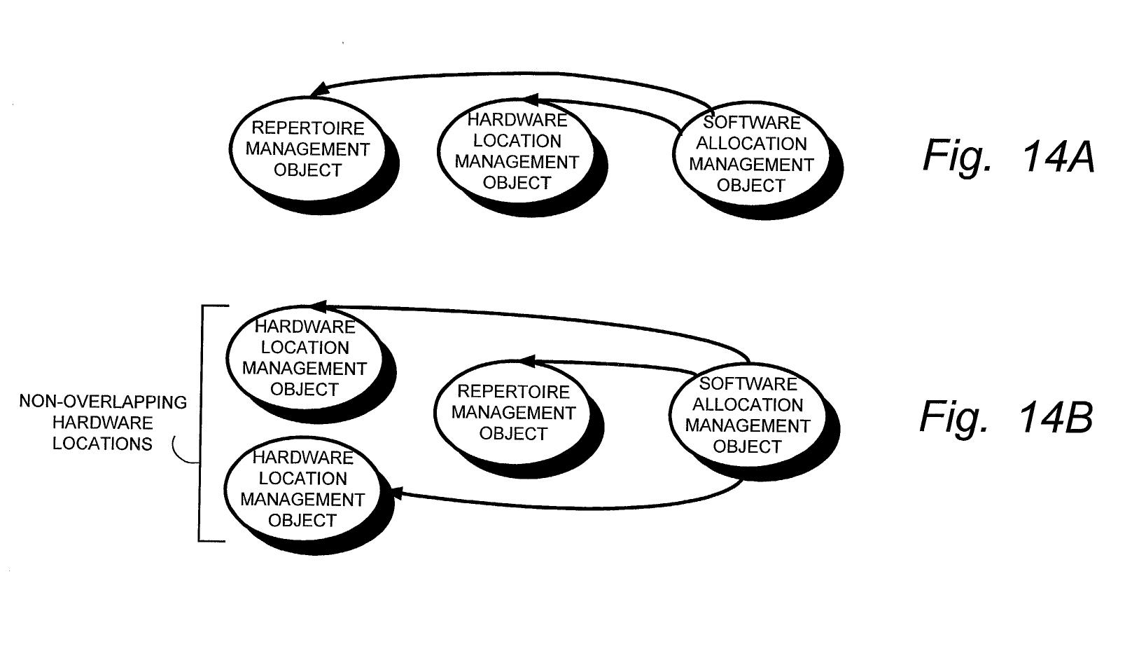

Another example scenario of execution of the software (load module) distribution operation is described in connection with FIG. 13A and FIG. 13B. In the example scenario of FIG. 13A and FIG. 13B, it is assumed that a software allocation manage object SWA-MAO₂ is created in the manner depicted by the software allocation object creation screen 439 of FIG. 13A. In particular, a software allocation manage object identified as SWA-MAO₂ (see dialog box 440 in FIG. 13A) is created by associating the repertoire ET155 with subrack 420X of telecommunications node 20. In this regard, the operator/user has selected repertoire ET155 in first list 441 and subrack 420X in second list 442. By selecting the box in second list 442 labeled as subrack 420-X, that box and all lower order boxes become highlighted (shaded in FIG. 13A).

In the example scenario of FIG. 13A and FIG. 13B, it is further assumed that a main processor board (MP) 510 having product identifier ROF 12345/6 Rev. R1 is mounted in slot 422-1 of subrack 420X, and that an extension terminal board (ET) 512 having product identifier ROF 9991 Rev. R2 is mounted in slot 422-k of subrack 420X. In accordance with the automatic downloading of action 11-7, as depicted by arrow 532 in FIG. 13B a copy of the installed version of load module CXC454 Rev. A [having load module LM₄ and load module manage object LM-MAO₄] is downloaded to main processor board (MP) 510 in slot 422-1 of subrack 420X to become the program on main processor board (MP) 510. Further, as indicated by arrows 534 and 535 respectively in FIG. 13B, copies of the installed versions of the load module CXC565/1 Rev. A [having load module LM₅ and load module manage object LM-MAO₅] and CXC878 Rev. D [having load module LM₇ load module manage object LM-MAO₇] are downloaded to the extension terminal board (ET) 512 in slot 422-k of subrack 420X to become the programs on processor 514.

By specifying the subrack 420X in second list 442 in the example scenario of FIG. 13A and FIG. 13B, software distribution function 100 knows to download a copy of the installed version of load module CXC454 Rev. A to any other main processors with the right product identifier which may be installed in subrack 420X (or which are currently installed in subrack 420X but which are lacking load module CXC454 Rev. A). In addition, specifying subrack 420X further means that any other extension terminal boards (ETs) with the right product identifier in any others of the slots 422-2 through 422-(k-1) are also to be downloaded copies of the installed versions of the load module CXC565/1 Rev. A and CXC878 Rev. D. Thus, when a higher order hierarchy level of hardware locations is specified when creating a software allocation manage object, all comparable hardware entities in lower order hardware locations receive a copy of the installed load module of the repertoire referenced by the software allocation manage object.

Thus, a repertoire can include load modules for a set of hardware type entities, so that when any member of the set of hardware entities is detected at a hardware location with which the repertoire is associated, an appropriate load module is downloaded to the member situated at the hardware location. That is, when the hardware location is equipped or configured with a hardware entity (e.g., action 11-5), the system can retrieve the product number of the hardware entity (action 11-6) and decide, using the SWA, which load module(s) shall be downloaded to the hardware entity. Moreover, for a given hardware entity, the repertoire may can one or more versions of load modules therefor, e.g., different revisions.

When a hardware entity is mounted in a hardware location which is referenced by a software allocation manage object, or a configuration activity creates a hardware device manage object, that hardware device is automatically attached by program manage objects reflecting the fact that the system knows what to load. Moreover, in one embodiment, illustrated for example in the scenario of FIG. 13A and FIG. 13B, all processors beneath the referenced entity location manage object are loaded in accordance with the information in the associated repertoire. Thus, the software (load modules) can be distributed on several levels by the creation of a single repertoire. As another example, a software allocation manage object can reference a slot as its hardware location, in which case the board processor mounted on a board inserted into that slot, and possibly all other processors which are mounted on that same board, are loaded automatically according to the repertoire manage object used to define the software allocation manage object. It is the meta-deta of the involved LMs that controls if a given load module will be loaded to a board processor (BP), or to any other kind of processor.

The foregoing example scenario of FIG. 12A and FIG. 12B, as well as the example scenario of FIG. 13A and FIG. 13B, illustrate creation and utilization of a simple software allocation manage object.

The software allocation manage objects are subdivided into four different subclasses. In other words, in addition to simple software allocation manage objects, there are three other distribution types of software allocation manage objects—multiple software allocation manage objects; redundant software allocation manage objects; and partitioning software allocation manage objects. Valid for all software allocation manage object subclasses are create, delete, set, and get methods. The attributes differ slightly between the different subclasses. The format of the information can differ from implementation to implementation. Typically it can be a row in a table of a relational database or a section in a plain text file.

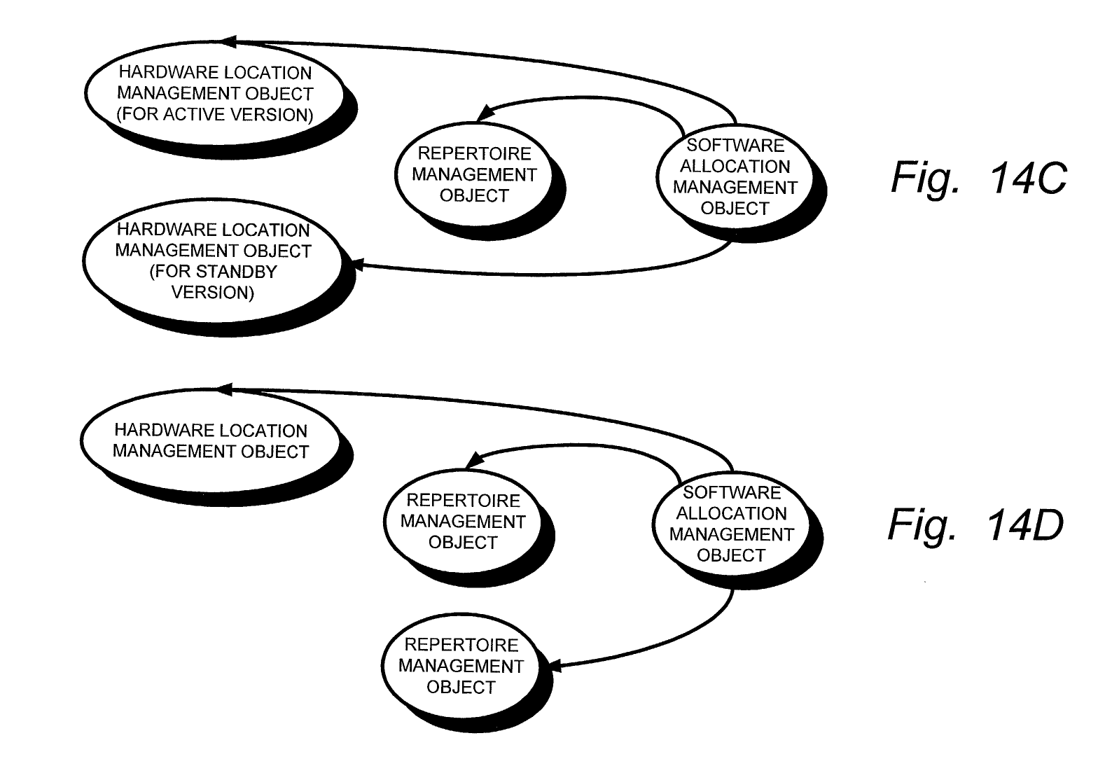

A simple software allocation manage object contains one reference to a repertoire manage object and one reference to a hardware location manage object, as basically depicted in FIG. 14A. The simple software allocation manage object enforces all suitable load modules to be loaded on the processors situated at the hardware location. Thus, for the simplest software allocation manage object class there are two important attributes, namely references to the repertoire and references to the hardware location.

In the multiple software allocation manage objects, basically illustrated in FIG. 14B, the referenced repertoire is loaded to all hardware entities situated in plural non-overlapping referenced hardware locations. For example, if the software allocation manage object SWA-MAO₁ of FIG. 13A had been created by referencing both (1) subrack 420-1 and (2) subrack 420-X, the software allocation would be a multiple software allocation manage object. The multiple software allocation manage object has one attribute referencing a repertoire and several attributes referencing hardware locations.

The redundant software allocation manage object, basically illustrated in FIG. 14C, is used for repertoires containing at least one load module geared to run as a redundant pair. The redundant software allocation manage object is used to control which load module will be started as active and which will be started as standby. The object has two different attributes referencing hardware locations, one attribute referencing the master location and another attribute for referencing the standby location. All redundant load modules of the referenced repertoire are started in the same way concerning hardware (HW) locations for active and standby versions. Thus, the software allocation manage object dealing with fault tolerant software has two attributes referencing hardware location—one for the master location and one for the standby location.

The partitioning software allocation manage object, illustrated in FIG. 14D, is used to state that each referenced repertoire is used on a fraction of the referenced hardware locations. The partitioning software allocation manage object class has several attributes which reference repertoires. Along with each repertoire referencing attribute there is an attribute which provides a fraction (e.g., a percentage) of the reference hardware location that shall run this particular repertoire. In other words, for each repertoire to be functionally distributed there is a pair of attributes, the reference attribute and the fraction attribute.

A manage object (MO) has a number of attributes which are essentially variables of that object and which are readable and sometimes also writable by an operator. Some attributes are of a special type, namely relational attributes (relations for short). These relational attributes contain a reference to another object and are the means to associate objects with each other, and thereby creating object models. For a partitioning SWA there are several relational attributes defined, i.e. the SWA has relation to several other objects, one for a HW location MO (preferably on a higher level than the slot level) and the rest for repertoire Mos. For a partitioning SWA, one of the relational attributes is a “fraction” attribute which specifies: for each referenced repertoire a fraction of HW location to load it on. This will only work if the referenced HW location MO identifies more than one processor, e.g. by referencing a subrack or a board with several processors mounted.

The present invention thus affords, among other things, a technique for distributing software (load modules) to processors in a telecommunications node or platform. In view of the present invention, an operator/user of management client computer 410 does not have to deal with product identifying information and load module identifiers (both of which can be awkward and human-unfriendly) in a situation of assigning software to processors of such products. Rather, simple repertoire names can be utilized. Moreover, the repertoires handle functional groups of load modules, and can be used to manage pools of processors where appropriate.

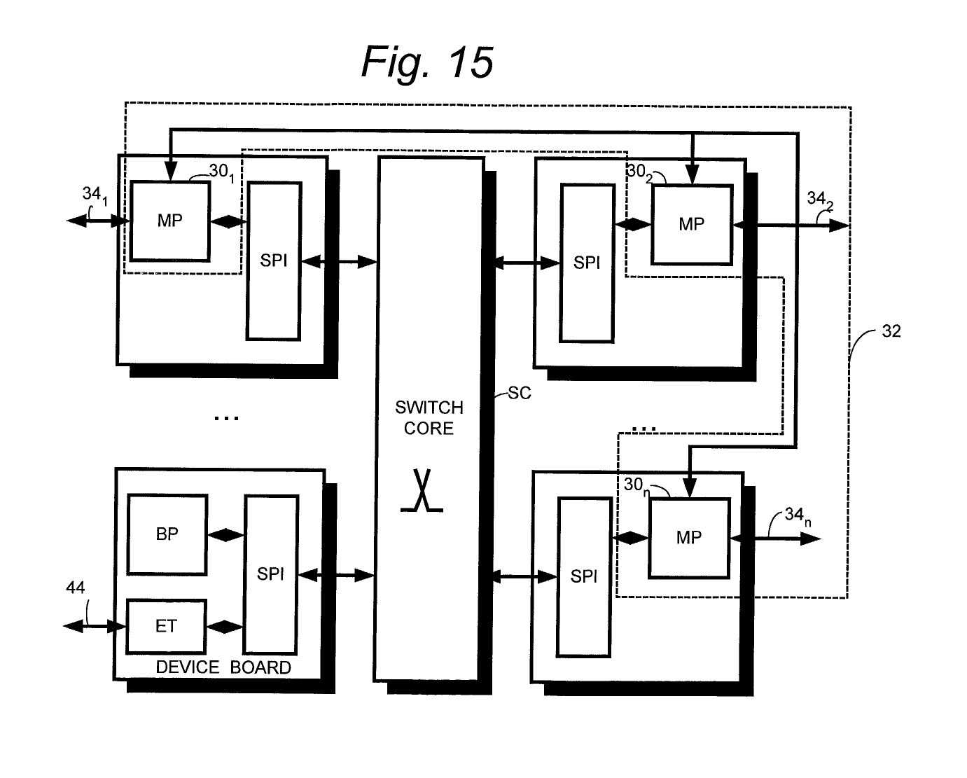

FIG. 15 shows one example embodiment of a ATM switch-based telecommunications platform having the software distribution function 100. In the embodiment of FIG. 15, each of the main processors 30 comprising main processor cluster (MPC) 32 are situated on a board known as a main processor (MP) board. The main processor cluster (MPC) 32 is shown framed by a broken line in FIG. 10. The main processors 30 of main processor cluster (MPC) 32 are connected through a switch port interface (SPI) to a switch fabric or switch core SC of the platform. All boards of the platform communicate via the switch core SC. All boards are equipped with a switch port interface (SPI). The main processor boards further have a main processor module. Other boards, known as device boards, have different devices, such as extension terminal (ET) hardware or the like. All boards are connected by their switch port interface (SPI) to the switch core SC. The software distribution function is running on the main processor cluster (MPC) except for the loading part that runs on the board processors (BPs).

Whereas the platform of FIG. 15 is a single stage platform, it will be appreciated by those skilled in the art that the software distribution function of the present invention can be implemented in a main processor cluster (MPC) realized in multi-staged platforms. Such multi-stage platforms can have, for example, plural switch cores (one for each stage) appropriately connected via suitable devices. The main processors 30 of the main processor cluster (MPC) 32 can be distributed throughout the various stages of the platform, with the same or differing amount of processors (or none) at the various stages.

Various aspects of ATM-based telecommunications are explained in the following: U.S. patent applications Ser. No. 09/188,101 [PCT/SE98/02325] and Ser. No. 09/188,265 [PCT/SE98/02326] entitled “Asynchronous Transfer Mode Switch”; U.S. patent application Ser. No. 09/188,102 [PCT/SE98/02249] entitled “Asynchronous Transfer Mode System”, all of which are incorporated herein by reference.

As understood from the foregoing, the present invention is not limited to an ATM switch-based telecommunications platform, but can be implemented with other types of multi-processor systems. Moreover, the invention can be utilized with single or multiple stage platforms. Aspects of multi-staged platforms are described in U.S. patent application Ser. No. 09/249,785 entitled “Establishing Internal Control Paths in ATM Node” and U.S. patent application Ser. No. 09/213,897 for “Internal Routing Through Multi-Staged ATM Node,” both of which are incorporated herein by reference.

The present invention applies to many types of apparatus, such as but not limited to) telecommunications platforms of diverse types, including (for example) base station nodes and base station controller nodes (radio network controller [RNC] nodes) of a cellular telecommunications system. Example structures showing telecommunication-related elements of such nodes are provided, e.g., in U.S. patent application Ser. No. 09/035,821 [PCT/SE99/00304] for “Telecommunications Inter-Exchange Measurement Transfer,” which is incorporated herein by reference.

Various other aspects of cluster support function 50 are described in the following, all of which are incorporated herein by reference: (1) U.S. patent application Ser. No. 09/467,018 filed Dec. 20, 1999, entitled “Internet Protocol Handler for Telecommunications Platform With Processor Cluster”; (2) U.S. patent application Ser. No. ______ (attorney docket: 2380-180), entitled “Software Distribution At A Multi-Processor Telecommunications Platform”; (3) U.S. patent application Ser. No. ______ (attorney docket: 2380-183), entitled “Replacing Software At A Telecommunications Platform”.

The present invention thus features an object model as seen by a system operator. The model provides the operator with the ability to distribute software over a multiprocessor platform in an easy and convenient way, since it deals with concepts on a higher functional level than commonly employed.

In the foregoing example implementations, the different layers (e.g., presentation layer, adaptation layer, resource layer) of the management structure are not to be accorded critical significance, but rather seen as part of a particular implementation architecture.

The objects of the management object model (manage objects [MOs]) are an interface through which the operator is supplied with certain system resources (in the illustrated examples, supplied with hardware units, load modules, repertoires, etc.). A manage object is also an object that is intuitive for an operator to handle (to create, to delete, to change) in order to achieve a certain behavior of the system, i.e., to manage the system (in the illustrated case, the software allocation, the repertoires, etc.).

A manage adaptation object (MAO) is a software object that is part of an implementation of an manage object. The manage adaptation objects (MAOs) as described herein are not necessary for the invention, but instead represent one way of implementing the object model.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A managed object system for distributing software load module to a processor of a telecommunications node, the node having hardware locations whereat hardware entities are mounted, the system comprising:
a load module manage object corresponding to the load module;
a repertoire manage object which specifies the load module manage object and a hardware entity;
a hardware location manage object for a hardware location of the node;
a software allocation manage object created by associating the repertoire manage object with the hardware location manage object;
wherein upon creation of the software allocation manage object and subsequent detection of configuring of the node with the hardware entity at the hardware location having the hardware location manage object, the load module corresponding to the load module manage object is downloaded to a processor of the hardware entity.

2. The apparatus of claim 1, wherein the repertoire manage object specifies plural load module manage objects having corresponding plural load modules, and wherein upon detection of the configuring of the node with the hardware entity, the load modules for the plural alternative load modules are downloaded to the processor of the hardware entity.

3. The apparatus of claim 2, wherein the plural alternative load modules are differing versions of a load module for the hardware entity.

4. The apparatus of claim 1, wherein the repertoire manage object specifies plural load module manage objects and corresponding plural hardware entities, and wherein upon detection of which of the plural hardware entities is situated at the hardware location having the hardware location manage object, the load module for the corresponding one of the plural load module manage objects is downloaded to a processor of the hardware entity situated at the hardware location.

5. The apparatus of claim 1, wherein the node has a hierarchical structure of levels of hardware locations comprising plural hardware location levels; wherein each hardware location level has a hardware location manage object; and wherein when the software allocation manage object is created by associating the repertoire manage object with a hardware location manage object for a higher hardware location level, the load module of the repertoire can be downloaded to processors of hardware entities mounted in the higher hardware location level and to processors of a lower hardware location level.

6. The apparatus of claim 5, wherein the repertoire manage object has plural types of load module manage objects for corresponding plural types of hardware entities, and wherein, in accordance with hardware entity type, load modules for at least some of the load module manage objects of the repertoire are downloaded to processors of hardware entities mounted in the higher hardware location level and load modules for at least some of the load module manage objects of the repertoire are downloaded to processors of a lower hardware location level, the downloading being in accordance with the hardware entity types situated at the hardware location levels.

7. The apparatus of claim 1, wherein the software allocation manage object associates one repertoire manage object with one hardware location manage object.

8. The apparatus of claim 1, wherein the software allocation manage object associates one repertoire manage object with plural hardware location manage objects, and wherein upon creation of the software allocation manage object and subsequent detection of configuring of the node with the hardware entity at the hardware locations of the plural hardware location manage objects, the load module corresponding to the load module manage object is downloaded to processors of hardware entities at plural hardware locations.

9. The apparatus of claim 1, wherein the software allocation manage object associates the repertoire manage object with an active hardware location manage object and a standby hardware location manage object.

10. The apparatus of claim 1, wherein the software allocation manage object associates several repertoire manage objects with one hardware location manage object.

11. The apparatus of claim 1, wherein the hardware location is one of a node element, a node subrack, and a node slot.

12. The apparatus of claim 1, wherein the node is one of a base station node and a radio network controller node.

13. A method of managing software distribution at a telecommunications node, the node having hardware locations whereat hardware entities are mounted, the method comprising:
providing a load module manage object corresponding to a load module;
providing a repertoire manage object which specifies the load module manage object and a hardware entity;
providing a hardware location manage object for a hardware location of the node;
creating a software allocation manage object by associating the repertoire manage object with the hardware location manage object;
detecting configuring of the node with the hardware entity at the hardware location having the hardware location manage object; and in response thereto
automatically downloading the load module corresponding to the load module manage object to a processor of the hardware entity.

14. The method of claim 13, further comprising:
providing the repertoire manage object to specify plural load module manage objects having corresponding plural load modules; and
downloading the load modules for the plural alternative load modules to the processor of the hardware entity.

15. The method of claim 14, wherein the plural alternative load modules are differing versions of a load module for the hardware entity.

16. The method of claim 13, further comprising:
providing the repertoire manage object to specify plural load module manage objects and corresponding plural hardware entities;
downloading the load module for the corresponding one of the plural load module manage objects to a processor of the hardware entity situated at the hardware location.

17. The method of claim 13, wherein the node has a hierarchical structure of levels of hardware locations comprising plural hardware location levels, and wherein the method further comprises:
providing a hardware location manage object for each hardware location level;
creating the software allocation manage object by associating the repertoire manage object with a hardware location manage object for a higher hardware location level; and in response thereto
automatically downloading the load module of the repertoire to processors of hardware entities mounted in the higher hardware location level and to processors of a lower hardware location level.

18. The method of claim 17, further comprising:
providing the repertoire manage object with plural types of load module manage objects for corresponding plural types of hardware entities; and
wherein, in accordance with hardware entity type,
(1) downloading load modules for at least some of the load module manage objects of the repertoire to processors of hardware entities mounted in the higher hardware location level;
(2) downloading load modules for at least some of the load module manage objects of the repertoire to processors of a lower hardware location level;
the downloading of steps (1) and (2) being in accordance with the hardware entity types situated at the hardware location levels.

19. The method of claim 13, further comprising the software allocation manage object associating one repertoire manage object with one hardware location manage object.

20. The method of claim 13, further comprising:
the software allocation manage object associating one repertoire manage object with plural hardware location manage objects;
downloading the load module corresponding to the load module manage object to processors of hardware entities at plural hardware locations.

21. The method of claim 13, wherein the software allocation manage object associates one repertoire manage object with an active hardware location manage object and a standby hardware location manage object.

22. The method of claim 13, wherein the software allocation manage object associates several repertoire manage objects with one hardware location manage object.
